(19) United States
(12) Patent Application Publication
(10) Pub. No.: US 2003/0066033 A1
(43) Pub. Date: Apr. 3, 2003

(54) Method of performing set operations on hierarchical objects

(76) Inventors: Harry George Direen, JR., Colorado Springs, CO (US); Kevin Lawrence Huck, Colorado Springs, CO (US); Christopher L. Brandin, Colorado Springs, CO (US)

Correspondence Address: Dale B. Halling, Suite 311, 24 South Weber Street, Colorado Springs, CO, 80903, US

(21) Appl. No.: 10/242,131

(22) Filed: Sep. 12, 2002

Related U.S. Application Data
(60) Provisional application No. 60/318,956, filed on Sep. 13, 2001.

(51) Int. Cl. G06F 17/00; G06F 17/24; G06F 17/21

(52) U.S. Cl. 715/513; 715/514

(57) ABSTRACT

A method of performing set operations on ordered sets includes the steps of receiving a first ordered set and a second ordered set. A set operation request between the first ordered set and the second ordered set is received. A modified binary search is performed between the first ordered set and the second ordered set to find an intersection set.

### RELATED APPLICATIONS

The present invention is claim priority on the provisional patent application Serial No. 60/318,956, filed on Sep. 13, 2001, entitled “Virtual Document Ordering and Set operations Using Couplet hierarchical Vectors”, assigned to the same assignee as the present application.

### FIELD OF THE INVENTION

The present invention relates generally to the field of computer data management systems and more particularly to a method of performing set operations on a flattened structured data document.

### BACKGROUND OF THE INVENTION

Structured data documents such as HTML (Hyper Text Markup Language), XML (extensible Markup Language) and SGML (Standard Generalized Markup Language) documents and derivatives use tags to describe the data associated with the tags. This has an advantage over databases in that not all the fields are required to be predefined. XML is presently finding widespread interest for exchanging information between businesses. XML appears to provide an excellent solution for internet business to business applications. Unfortunately, XML documents require a lot of memory and therefore are time consuming and difficult to search.

Thus there exists a need for a method of performing set operations on a flattened structured data document that improves the speed of searching XML documents. The present invention is described with respect to mark-up language documents, it can applied to any ordered sets and to methods of ordering sets.

### BRIEF DESCRIPTION OF THE DRAWINGS

FIG. 1 is an example of an XML document in accordance with one embodiment of the invention;

FIG. 2 is an example of a flattened data document in accordance with one embodiment of the invention;

FIG. 3 is a block diagram of a system for storing a flattened data document in accordance with one embodiment of the invention;

FIG. 4 shows two examples of a map store cell in accordance with one embodiment of the invention;

FIG. 5 is a flow chart of a method of storing a structured data document in accordance with one embodiment of the invention;

FIG. 6 is a flow chart of a method of storing a structured data document in accordance with one embodiment of the invention;

FIG. 7 is a flow chart of a method of storing a structured data document in accordance with one embodiment of the invention;

FIG. 8 is a block diagram of a system for storing a flattened structured data document in accordance with one embodiment of the invention;

FIG. 9 is a block diagram of a system for storing a flattened structured data document in accordance with one embodiment of the invention;

FIG. 10 is a flow chart of the steps used in a method of storing a flattened structured data document in accordance with one embodiment of the invention;

FIG. 11 is a flow chart of the steps used in a method of storing a flattened structured data document in accordance with one embodiment of the invention;

FIG. 12 is a schematic diagram of a location of a map index in accordance with one embodiment of the invention;

FIG. 13 is a schematic diagram of a map index and a duplicate array in accordance with one embodiment of the invention;

FIG. 14 is a schematic diagram of a map index and a second level duplicate tree structure in accordance with one embodiment of the invention;

FIG. 15 is a schematic diagram of a map index and a third level duplicate tree structure in accordance with one embodiment of the invention;

FIG. 16 is a schematic diagram of a hierarchical structured data document system having a duplicate tree structure in accordance with one embodiment of the invention;

FIG. 17 is a flow chart of the steps used in a method of operating a hierarchical structured data document system having a duplicate tree structure in accordance with one embodiment of the invention;

FIGS. 18 & 19 are a flow chart of the steps used in a method of operating a hierarchical structured data document system having a duplicate tree structure in accordance with one embodiment of the invention;

FIG. 20 is an example of an XML document in accordance with one embodiment of the invention;

FIG. 21 is an example of a flatten XML document of FIG. 20 in accordance with one embodiment of the invention;

FIG. 22 is a pair of examples of couplet hierarchical vectors in accordance with one embodiment of the invention;

FIG. 23 is a schematic diagram of a system for storing flattened data documents in accordance with one embodiment of the invention;

FIG. 24 is a flow chart of a method of defining a couplet hierarchical vector in accordance with one embodiment of the invention;

FIG. 25 is a flow chart of a method of performing set operations on a flattened structured data document in accordance with one embodiment of the invention; and

FIG. 26 is a flow chart of a method of performing set operations on ordered sets in accordance with one embodiment of the invention.

### DETAILED DESCRIPTION OF THE DRAWINGS

A method of performing set operations on ordered sets includes the steps of receiving a first ordered set and a second ordered set. A set operation request between the first ordered set and the second ordered set is received. A modified binary search is performed between the first ordered set and the second ordered set to find an intersection set.

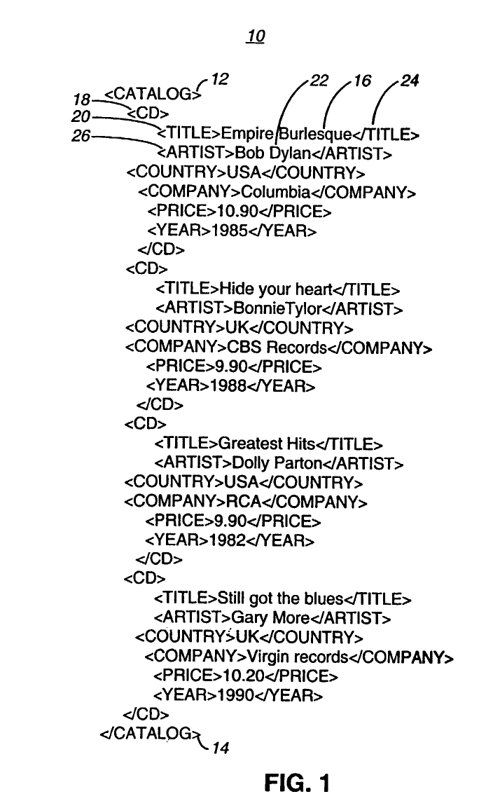

FIG. 1 is an example of an XML document 10 in accordance with one embodiment of the invention. The words between the < > are tags that describe the data. This document is a catalog 12. Note that all tags are opened and later closed. For instance <catalog> 12 is closed at the end of the document </catalog> 14. The first data item is “Empire Burlesque” 16. The tags <CD> 18 and <TITLE> 20 tell us that this is the title of the CD (Compact Disk). The next data entry is “Bob Dylan” 22, who is the artist. Other compact disks are described in the document.

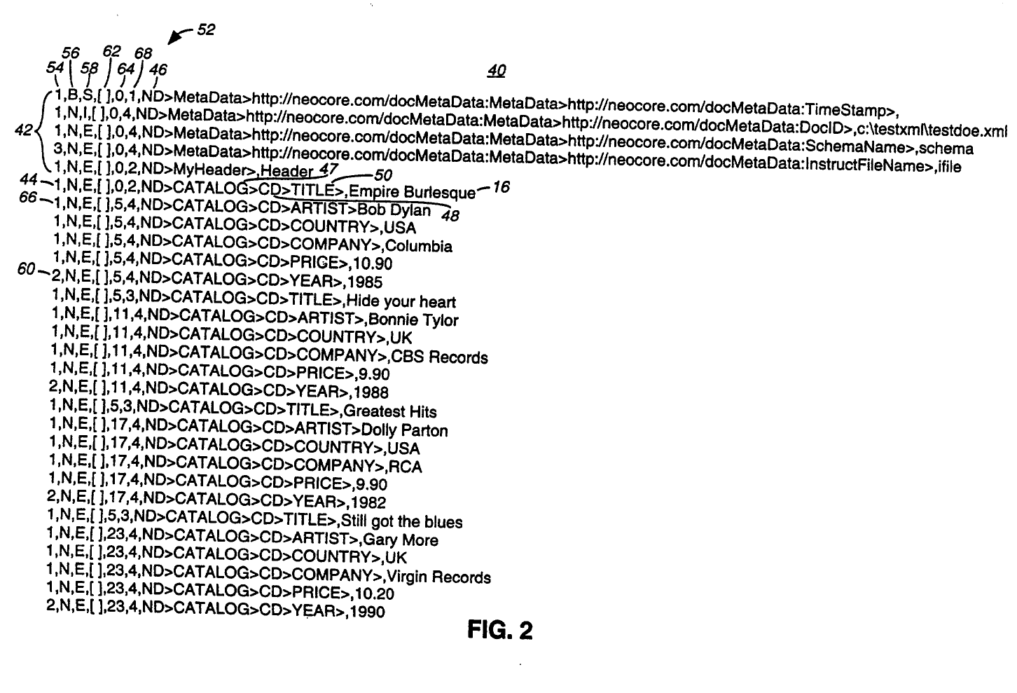

FIG. 2 is an example of a flattened data document 40 in accordance with one embodiment of the invention. The first five lines 42 are used to store parameters about the document. The next line 44 shows a line that has flattened all the tags relating to the first data entry 16 of the XML document 10. Note that the tag <ND> 46 is added before every line but is not required by the invention. The next tag is CATALOG> 47 which is the same as in the XML document 10. Then the tag CD> 48 is shown and finally the tag TITLE> 50. Note this is the same order as the tags in the XML document 10. A plurality of formatting characters 52 are shown to the right of each line. The first column is the n-tag level 54. The n-tag defines the number of tags that closed in that line. Note that first line 44, which ends with the data entry “Empire Burlesque” 16, has a tag 24 (FIG. 1) that closes the tag TITLE. The next tag 26 opens the tag ARTIST. As a result the n-tag for line 44 is a one. Note that line 60 has an n-tag of two. This line corresponds to the data entry 1985 and both the YEAR and the CD tags are closed.

The next column 56 has a format character that defines whether the line is first (F) or another line follows it (N-next) or the line is the last (L). The next column contains a line type definition 58. Some of the line types are: time stamp (S); normal (E); identification (I); attribute (A); and processing (P). The next column 62 is a delete level and is enclosed in a parenthesis. When a delete command is received the data is not actually erased but is eliminated by entering a number in the parameters in a line to be erased. So for instance if a delete command is received for “Empire Burlesque” 16, a “1” would be entered into the parenthesis of line 44. If a delete command was received for “Empire Burlesque” 16 and <TITLE>, </TITLE>, a “2” would be entered into the parenthesis. The next column is the parent line 64 of the current line. Thus the parent line for the line 66 is the first line containing the tag CATALOG. If you count the lines you will see that this is line five (5) or the preceding line. The last column of formatting characters is a p-level 68. The p-level 68 is the first new tag opened but not closed. Thus at line 44, which corresponds to the data entry “Empire Burlesque” 16, the first new tag opened is CATALOG. In addition the tag CATALOG is not closed. Thus the p-level is two (2).

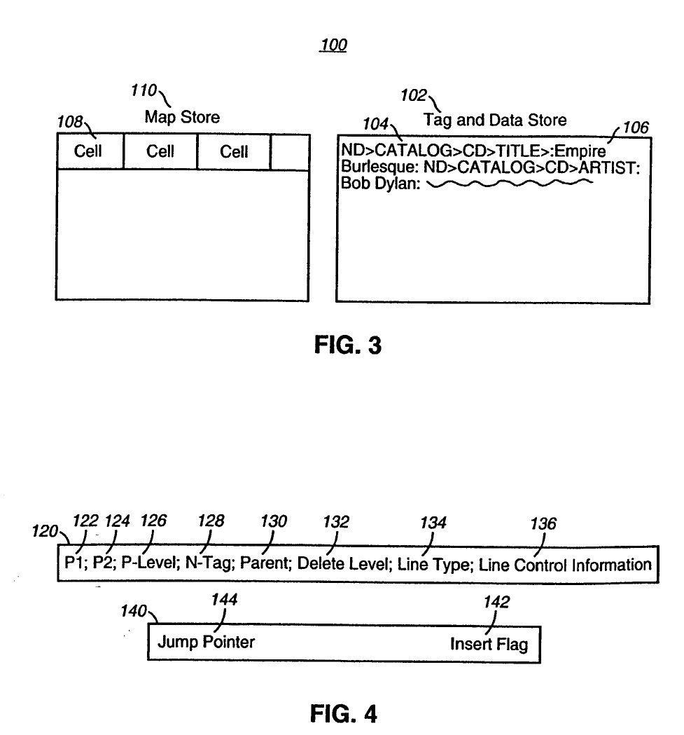

FIG. 3 is a block diagram of a system 100 for storing a flattened data document in accordance with one embodiment of the invention. Once the structured data document is flattened as shown in FIG. 2, it can be stored. Each unique tag or unique set of tags for each line is stored to a tag and data store 102. The first entry in the tag and data store is ND>CATALOG>CD>TITLE> 104. Next the data entry “Empire Burlesque” 106 is stored in the tag and data store 102. The pointers to the tag and data entry in the tag and data store 102 are substituted into line 44. Updated line 44 is then stored in a first cell 108 of the map store 110. In one embodiment the tag store and the data store are separate. The tag and data store 102 acts as a dictionary, which reduces the required memory size to store the structured data document. Note that the formatting characters allow the structured data document to be completely reconstructed.

FIG. 4 shows two examples of a map store cell in accordance with one embodiment of the invention. The first example 120 works as described above. The cell 120 has a first pointer (P₁) 122 that points to the tag in the tag and data store 102 and a second pointer (P₂) 124 that points to the data entry. The other information is the same as in a flattened line such as: p-level 126; n-tag 128; parent 130; delete level 132; line type 134; and line control information 136. The second cell type 140 is for an insert. When an insert command is received a cell has to be moved. The moved cell is replaced with the insert cell 140. The insert cell has an insert flag 142 and a jump pointer 144. The moved cell and the inserted cell are at the jump pointer.

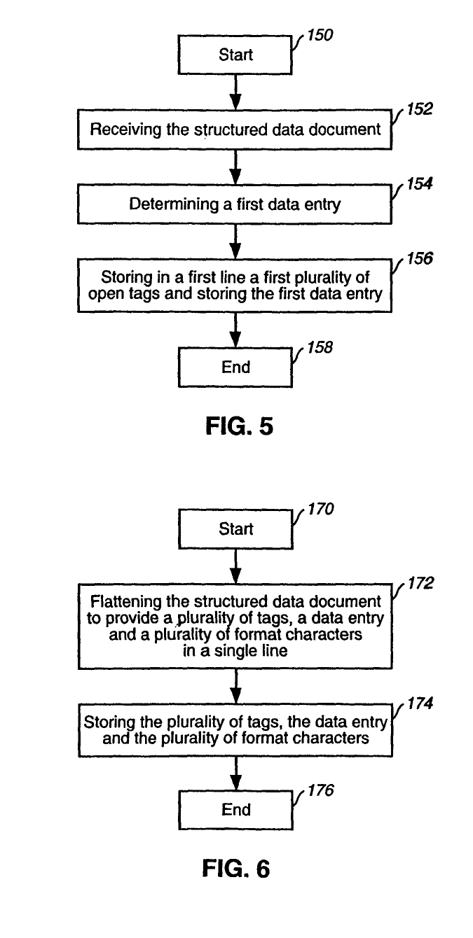

FIG. 5 is a flow chart of a method of storing a structured data document. The process starts, step 150, by receiving the structured data document at step 152. A first data entry is determined at step 154. In one embodiment, the first data entry is an empty data slot. At step 156 a first plurality of open tags and the first data entry is stored which ends the process at step 158. In one embodiment a level of a first opened tag is determined. The level of the first opened tag is stored. In another embodiment, a number of consecutive tags closed after the first data entry is determined. This number is then stored. A line number is stored.

In one embodiment, a next data entry is determined. A next plurality of open tags proceeding the next data entry is stored. These steps are repeated until a next data entry is not found. Note that the first data entry may be a null. A plurality of format characters associated with the next data entry are also stored. In one embodiment the flattened data document is expanded into the structured data document using the plurality of formatting characters.

FIG. 6 is a flow chart of a method of storing a structured data document. The process starts, step 170, by flattening the structured data document to a provide a plurality of tags, a data entry and a plurality of format characters in a single line at step 172. At step 174 the plurality of tags, the data entry and the plurality of format characters are stored which ends the process at step 176. In one embodiment, the plurality of tags are stored in a tag and data store. In addition, the plurality of format characters are stored in map store. The data entry is stored in the tag and data store. A first pointer in the map store points to the plurality of tags in the tag and data store. A second pointer is stored in the map store that points to the data store. In one embodiment, the structured data document is received. A first data entry is determined. A first plurality of open tags proceeding the first data entry and the first data entry are placed in a first line. A next data entry is determined. A next plurality of open tags proceeding the next data entry is placed in the next line. These steps are repeated until a next data entry is not found. In one embodiment a format character is placed in the first line. In one embodiment the format character is a number that indicates a level of a first tag that was opened. In one embodiment the format character is a number that indicates a number of tags that are consecutively closed after the first data entry. In one embodiment the format character is a number that indicates a line number of a parent of a lowest level tag. In one embodiment the format character is a number that indicates a level of a first tag that was opened but not closed. In one embodiment the format character is a character that indicates a line type. In one embodiment the format character indicates a line control information. In one embodiment the structured data document is an extensible markup language document. In one embodiment the next data entry is placed in the next line.

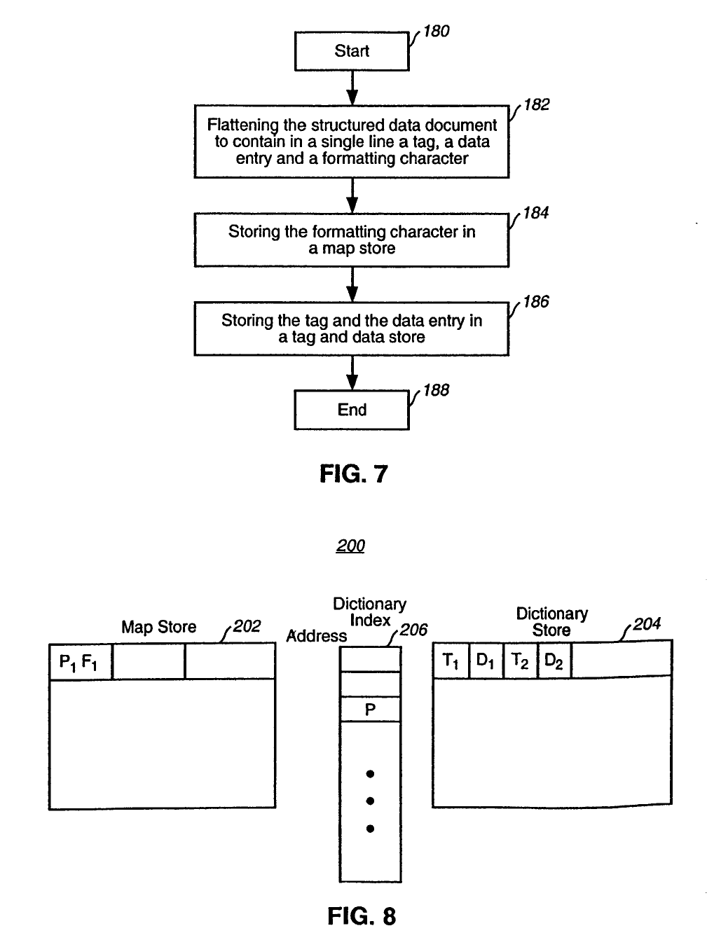

FIG. 7 is a flow chart of a method of storing a structured data document. The process starts, step 180, by flattening the structured data document to contain in a single line a tag, a data entry and a formatting character at step 182. The formatting character is stored in a map store at step 184. At step 186 the tag and the data entry are stored in a tag and data store which ends the process at step 188. In one embodiment a first pointer is stored in the map store that points to the tag in the tag and data store. A second pointer is stored in the map store that points to the data entry in the tag and data store. In one embodiment a cell is created in the map store for each of the plurality of lines in a flattened document. A request is received to delete one of the plurality of data entries. The cell associated with the one of the plurality of data entries is determined. A delete flag is set. Later a restore command is received. The delete flag is unset. In one embodiment, a request to delete one of a plurality of data entries and a plurality of related tags is received. A delete flag is set equal to the number of the plurality of related tags plus one. In one embodiment, a request is received to insert a new entry. A previous cell containing a proceeding data entry is found. The new entry is stored at an end of the map store. A contents of the next cell is moved after the new entry. An insert flag and a pointer to the new entry is stored in the next cell. A second insert flag and second pointer is stored after the contents of the next cell.

Thus there has been described a method of flattening a structured data document. The process of flattening the structured data document generally reduces the number lines used to describe the document. The flattened document is then stored using a dictionary to reduce the memory required to store repeats of tags and data. In addition, the dictionary (tag and data store) allows each cell in the map store to be a fixed length. The result is a compressed document that requires less memory to store and less bandwidth to transmit.

FIG. 8 is a block diagram of a system 200 for storing a flattened structured data document in accordance with one embodiment of the invention. The system 200 has a map store 202, a dictionary store 204 and a dictionary index 206. Note that this structure is similar to the system of FIG. 3. The dictionary store 204 has essentially the same function as the map and tag store (FIG. 3) 102. The difference is that a dictionary index 206 has been added. The dictionary index 206 is an associative index. An associative index transforms the item to be stored, such as a tag, tags or data entry, into an address. Note that in one embodiment the transform returns an address and a confirmer as explained in the U.S. patent application Ser. No. 09/419,217, entitled “Memory Management System and Method” filed on Oct. 15, 1999, assigned to the same assignee as the present application and hereby incorporated by reference. The advantage of the dictionary index 206 is that when a tag or data entry is received for storage it can be easily determined if the tag or data entry is already stored in the dictionary store 204. If the tag or data entry is already in the dictionary store the offset in the dictionary can be immediately determined and returned for use as a pointer in the map store 202.

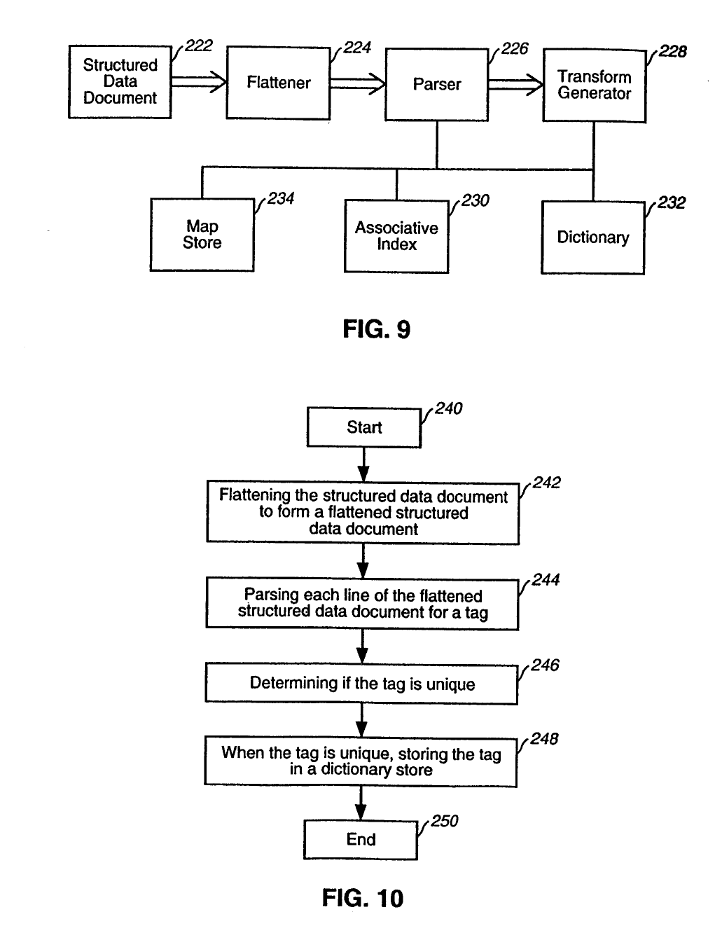

FIG. 9 is a block diagram of a system 220 for storing a flattened structured data document in accordance with one embodiment of the invention. A structured data document 222 is first processed by a flattener 224. The flattener 224 performs the functions described with respect to FIGS. 1 & 2. A parser 226 then determines the data entries and the associated tags. One of the data entries is transformed by the transform generator 228. This is used to determine if the data entry is in the associative index 230. When the data entry is not in the associative index 230, it is stored in the dictionary 232. A pointer to the data in the dictionary is stored at the appropriate address in the associative index 230. The pointer is also stored in a cell of the map store 234 as part of a flattened line.

FIG. 10 is a flow chart of the steps used in a method of storing a flattened structured data document in accordance with one embodiment of the invention. The process starts, step 240, by flattening the structured data document to form a flattened structured data document at step 242. Each line of the flattened structured data document is parsed for a tag at step 244. Next it is determined if the tag is unique at step 246. When the tag is unique, step 248, the tag is stored in a dictionary store which ends the process at step 250. In one embodiment a tag dictionary offset is stored in the map store. A plurality of format characters are stored in the map store. When a tag is not unique, a tag dictionary offset is determined. The tag dictionary offset is stored in the map store.

In one embodiment, the tag is transformed to form a tag transform. An associative lookup is performed in a dictionary index using the tag transform. A map index is created that has a map pointer that points to a location in the map store of the tag. The map pointer is stored at an address of the map index that is associated with the tag transform.

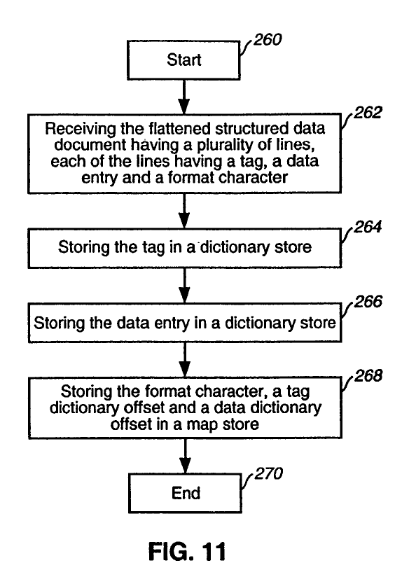

FIG. 11 is a flow chart of the steps used in a method of storing a flattened structured data document in accordance with one embodiment of the invention. The process starts, step 260, by receiving the flattened structured data document that has a plurality of lines at step 262. Each of the plurality of lines contains a tag, a data entry and a format character. The tag is stored in a dictionary store at step 264. The data entry is stored in the dictionary store at step 266. At step 268 the format character, a tag dictionary offset and a data dictionary offset are stored in a map store which ends the process at step 270. In one embodiment, the tag is transformed to form a tag transform. The tag dictionary offset is stored in a dictionary index at an address pointed to by the tag transform. In one embodiment, it is determined if the tag is unique. When the tag is unique, the tag is stored in the dictionary store otherwise the tag is not stored (again) in the dictionary store. To determine if the tag is unique, it is determined if a tag pointer is stored in the dictionary index at an address pointed to by the tag transform.

In one embodiment, the data entry is transformed to form a data transform. The data dictionary offset is stored in the dictionary index at an address pointed to by the data transform. In one embodiment each of the flattened lines has a plurality of tags.

In one embodiment, a map index is created. Next it is determined if the tag is unique. When the tag is unique, a pointer to a map location of the tag is stored in the map index. When the tag is not unique, it is determined if a duplicates flag is set. When the duplicates flag is set, a duplicates count is incremented. When the duplicates flag is not set, the duplicates flag is set. The duplicates count is set to two. In one embodiment a transform of the tag with an instance count is calculated to form a first instance tag transform and a second instance tag transform. A first map pointer is stored in the map index at an address associated with the first instance transform. A second map pointer is stored in the map index at an address associated with the second instance transform.

In one embodiment a transform of the tag with an instances count equal to the duplicates count is calculated to form a next instance tag transform. A next map pointer is stored in the map index at an address associated with the next instance transform.

In one embodiment, a map index is created. Next it is determined if the data entry is unique. When the data entry is unique, a pointer to a map location of the tag is stored.

Thus there has been described an efficient manner of storing a structured data document that requires significantly less memory than conventional techniques. The associative indexes significantly reduces the overhead required by the dictionary.

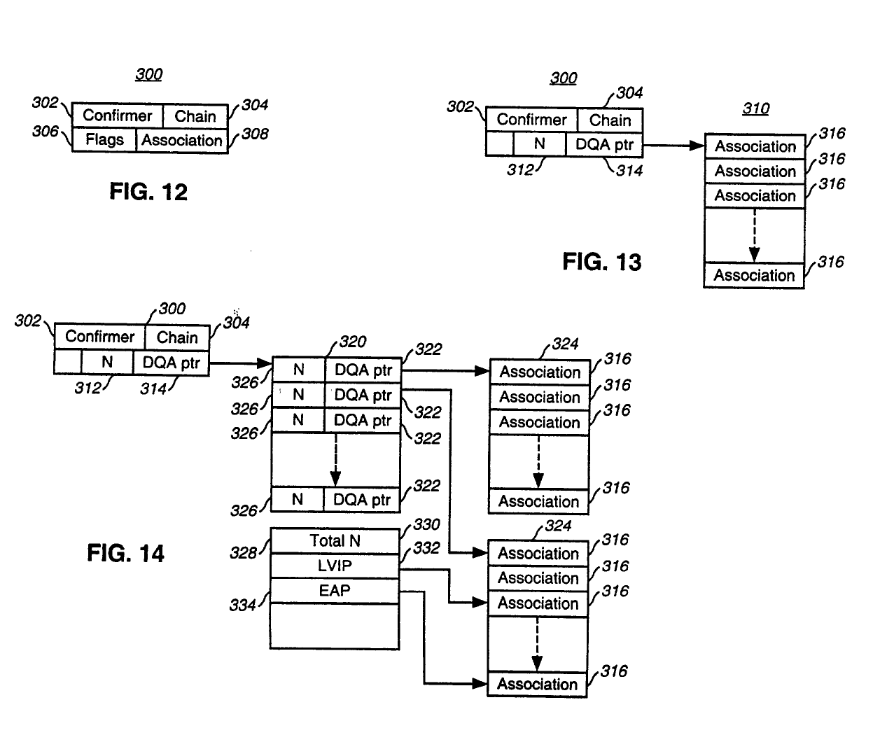

FIG. 12 is a schematic diagram of a location of a map index 300 in accordance with one embodiment of the invention. The location 300 in the map index contains a confirmer 302 in one embodiment. The confirmer 302 is part of the associative memory scheme explained in the U.S. patent application Ser. No. 09/419,217, entitled “Memory Management System and Method” filed on Oct. 15, 1999, assigned to the same assignee as the present application and hereby incorporated by reference. The chain 304 is used to store collisions (collisions occur when two items have the same address but are not duplicates and therefor have different confirmers). The chain points to the location where the collision is stored. The flags section 306 contains the primary and allocated flags (see Ser. No. 09/419,217 “Memory Management System and Method” referenced above). The flags also contain an indicator as to whether there is a duplicate tree. The association 308 is a map pointer that points to the location where the item is stored in the map store 234 (see FIG. 10).

FIG. 13 is a schematic diagram of a map index 300 and a duplicate array (first level duplicate array, outer-most level) 310 in accordance with one embodiment of the invention. When an exact duplicate of an item needs to be stored, a duplicate array 310 is created. The location in the map index 300 has a slightly different structure, when a duplicate array is created. The flags section 306 and association 308 are converted to an N section 312 and a duplicate array pointer 314. The N section 312 contains the primary and allocated flags and the number of levels in the duplicate tree. The duplicate array pointer 314 points to the duplicate array 310. The duplicate array 310 contains the map pointers 316. Note that the duplicate array 310 may not be full of map pointers (associations) 316.

FIG. 14 is a schematic diagram of a map index and a second level duplicate tree structure in accordance with one embodiment of the invention. The structure of the map index 300 is the same as in FIG. 13 except that the pointer 314 points to a pointer array 320. The pointer array 320 contains array pointers (first array pointer, second array pointer) 322 that point to second level arrays (a second level duplicate array, outer-most level) 324. The second level arrays 324 contain associations (map pointer) 316. Each location (filled) contains an N section 326. The N section 326 indicates the number of duplicates stored in the associated second level array 324. In one embodiment, an information array 328 is also created for a second level duplicate tree structure. The information array 328 may contain the total number 330 of associations (map pointers) in all of the second level arrays 324. A last valid entry pointer 332 points to the last association stored in any of the second level arrays 324. The associations 316 may not be stored in every location of the second level arrays. This is because of the way inserts and deletes are handled. An end of arrays pointer 334 points to the end of the second level arrays. Note that the second level arrays 324 are created one at a time as they are needed. Note, each of the arrays 320, 324 are of a fixed sized (e.g., 16 locations, addresses and x bytes).

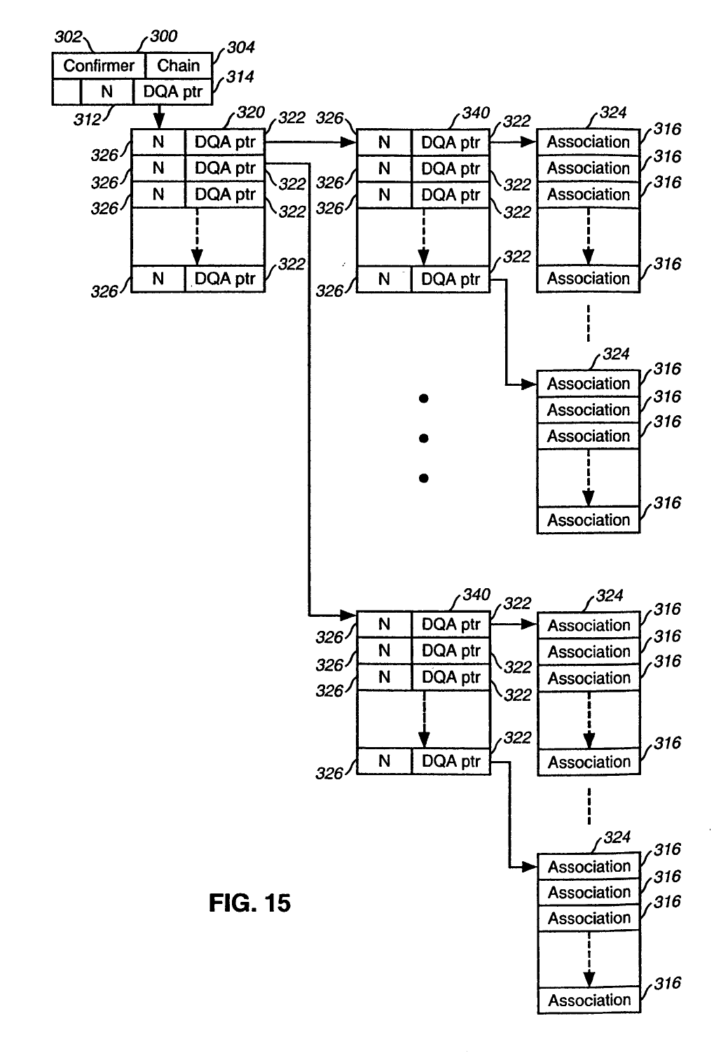

FIG. 15 is a schematic diagram of a map index and a third level duplicate tree structure in accordance with one embodiment of the invention. This example is similar to FIG. 14 except a second level of pointer arrays 340 have been added. As will be apparent to those skilled in the art the number of duplicate tree levels can be expanded to fit as many duplicates as are required to be stored. Note that in one embodiment, the associations are stored in numerical order. As a result a hole must be opened up in the association list when inserting an association in the middle of an array. Instead of shifting long lists of associations, new empty arrays may be added to make room for new associations. When a new association is added in the middle of an array, the duplicate array is checked to determine if an empty location exists in the array. If the current array is full, the array above and array below (adjacent arrays) are checked to determine if they are full. If one of these arrays has an empty location the associations are shifted to make room for the new association. When both of the adjacent arrays are also full, it is determined if a new array may be added. When a new array may be added, a new array is created and inserted into the duplicate arrays. The associations are then shifted into the new array to make room for the new association. This approach will leave holes in the duplicate tree structure, however this method prevents the entire list of duplicates from having to shifted every time a duplicate is inserted or removed from the middle of the list.

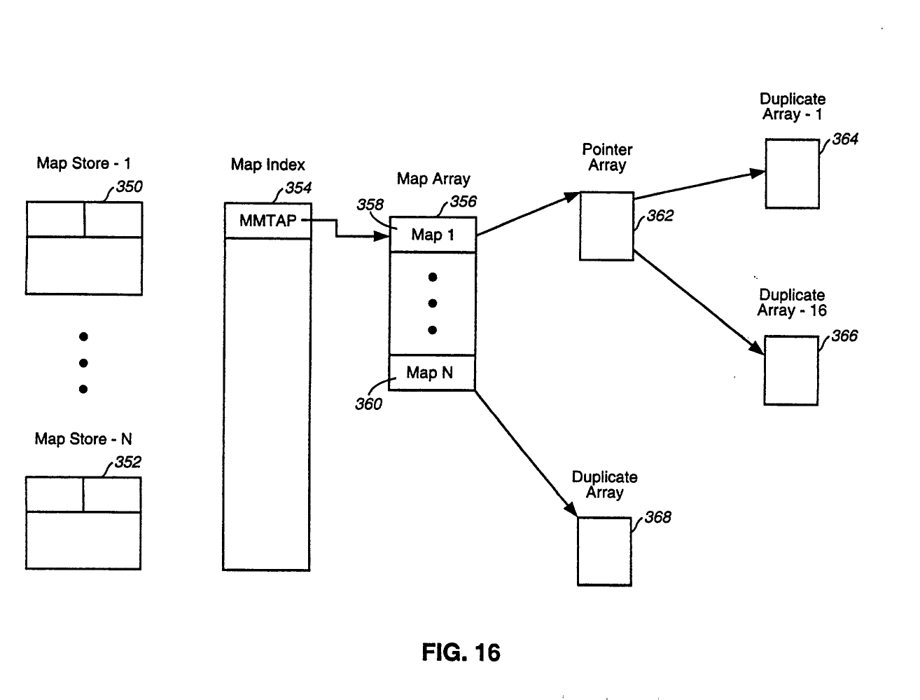

FIG. 16 is a schematic diagram of a hierarchical structured data document system having a duplicate tree structure in accordance with one embodiment of the invention. In this figure multiple map stores 350, 352 are indexed by a single map index 354. When a duplicate occurs, the first array created is a map array (multiple map tree array) 356. Thus there will be a map array for every duplicate location in the map index 354. Each map array includes a plurality of pointers 358, 360. The first pointer 358 points to the duplicate tree structure for the first map store 350. In the example the first pointer 358 points to a pointer array 362. The pointer array 362 has a plurality of duplicate pointers that point to a plurality of duplicate arrays 364, 366. Another pointer 360 in the map array 356 points to a first level duplicate tree structure having a single duplicate array 368. A multiple map tree pointer 370 points to the map array 356.

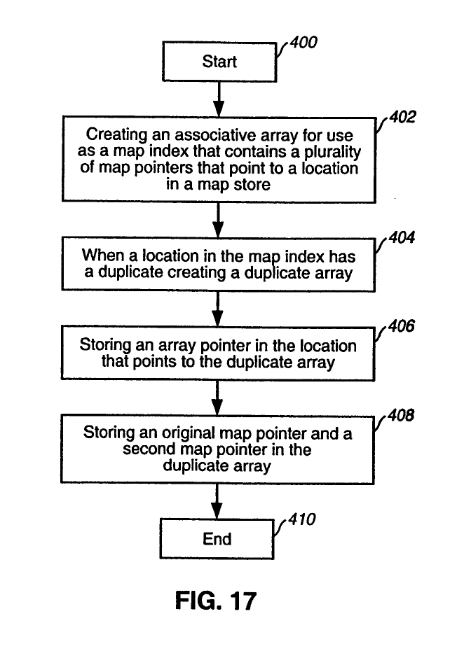

FIG. 17 is a flow chart of the steps used in a method of operating a hierarchical structured data document system having a duplicate tree structure in accordance with one embodiment of the invention. The process starts, step 400, by creating an associative array for use as a map index that contains a plurality of map pointers that point to a location in a map store at step 402. When a location in the map index has a duplicate, a duplicate array is created at step 404. An array pointer is stored in the location that points to the duplicate array at step 406. At step 408 an original map pointer and a second map pointer is stored in the duplicate array which ends the process at step 410. In one embodiment, an indicator of the number of duplicates is stored in the location of the map index. When the location in the map index has a plurality of duplicates, it is determined if the plurality of duplicates is greater than a first predetermined number and less than a second predetermined number. When the plurality of duplicates is greater than a first predetermined number and less than a second predetermined number, creating a pointer array and at least two duplicate arrays. At least two pointers are stored in the pointer array that point to the at least two duplicate arrays.

In one embodiment, a multiple map tree array is created. An array pointer that points to the pointer array is stored in a location of the multiple map tree array. Next a multiple map tree array pointer 370 (See FIG. 16) is stored in the location in the map index.

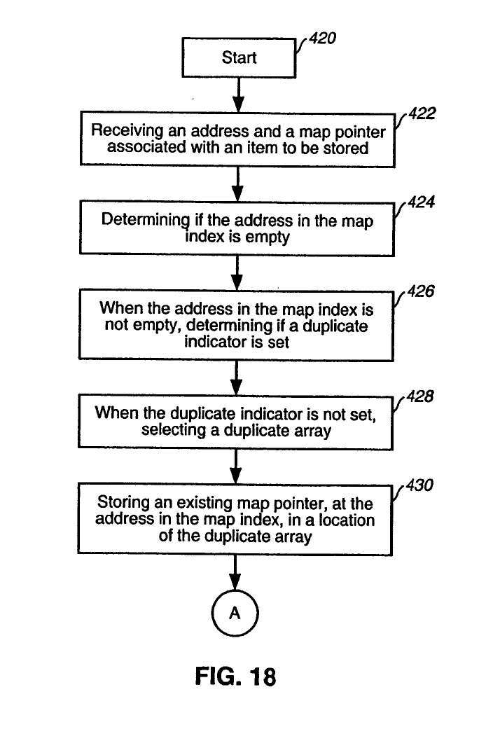

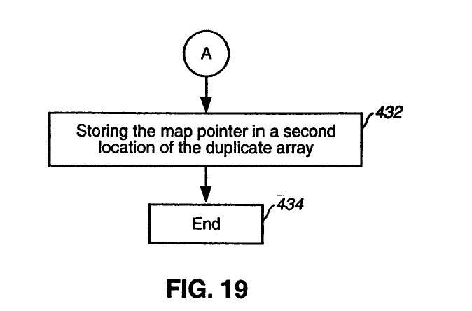

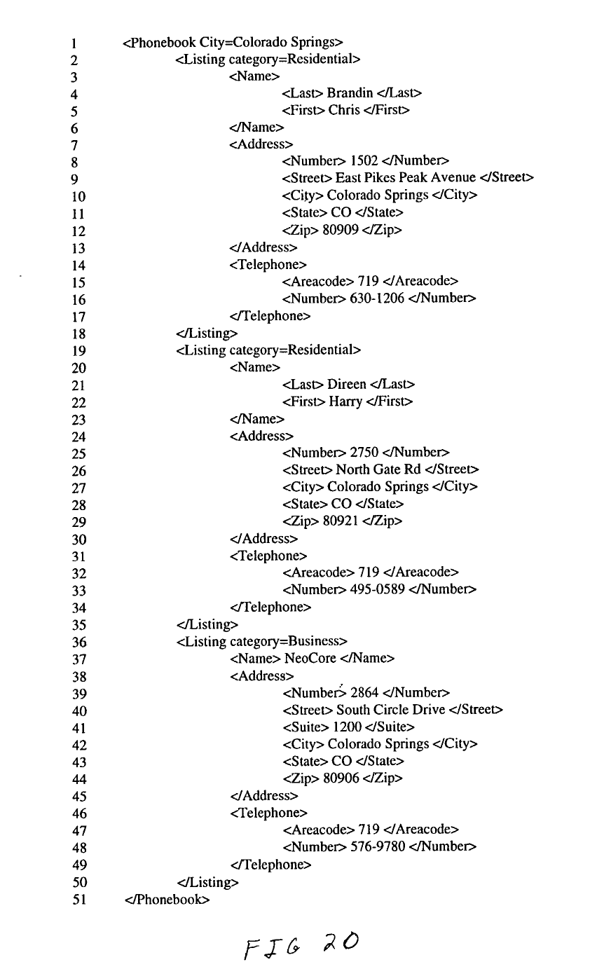

FIGS. 18 & 19 are a flow chart of the steps used in a method of operating a hierarchical structured data document system having a duplicate tree structure in accordance with one embodiment of the invention. The process starts, step 420, by receiving an address and a map pointer associated with an item to be stored at step 422. Next, it is determined if the address in the map index is empty at step 424. When the address in the map index is not empty, it is determined if a duplicate indicator is set at step 426. When the duplicate indicator is not set, a duplicate array is selected at step 428. An existing map pointer, at the address in the map index, is stored in a location of the duplicate array at step 430. At step 432 the map pointer is stored in a second location of the duplicate array which ends the process at step 434. In one embodiment, the duplicate indicator is set to a first level. A pointer to the duplicate array is stored. In one embodiment, a multiple map tree array is created. A tree pointer is stored in a location of the multiple map tree array.

In one embodiment, when the duplicate indicator is set, a level of the duplicate indicator is determined. When the level of the duplicate indicator is a first level, it is determined if a first level duplicate array is full. When the first level duplicate array is not full, the map pointer is stored in the first level duplicate array. When the first level duplicate array is full, a pointer array is created having a location containing a first array pointer. The first level duplicate array is moved to a second level duplicate array and pointed to by the first array pointer. Next a second-second level duplicate array is created. A map pointer is stored in a location of the second-second level duplicate array. A second array pointer is stored in a second location of the pointer array. The level of the duplicate indicator is updated to two. In one embodiment, an information array is created. A number of pointers in a second level arrays is stored in the information array. A last valid item pointer is stored in the information array. An end of arrays pointer is stored in the information array.

In one embodiment, when the duplicate indicator is set, a level of the duplicate indicator is determined. When the level of the duplicate indicator is a second level or greater, determining if the map pointer needs to be inserted into a full array at an outer-most level. When the map pointer needs to be inserted into a full array, determining if the outer-most level has a full complement of arrays. When the outer-most level does not have a full complement of arrays, creating a new outer-most array. A portion of the full array is moved into the new outer-most array. In one embodiment, the new outermost array is only created when an adjacent arrays are full.

Thus there has been described an efficient method of handling duplicates in an associative memory system. The system and method significantly reduce the collisions that result from storing duplicates inside of the associative memory.

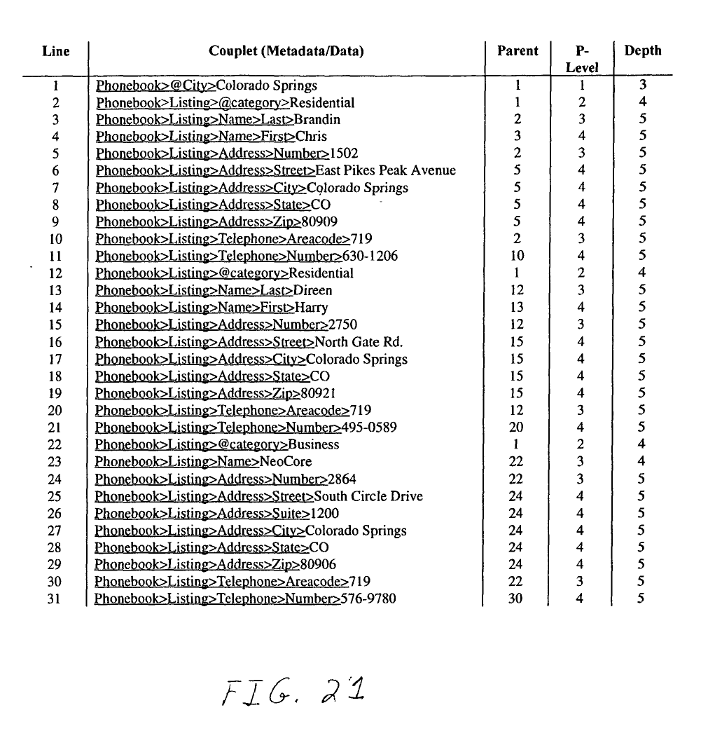

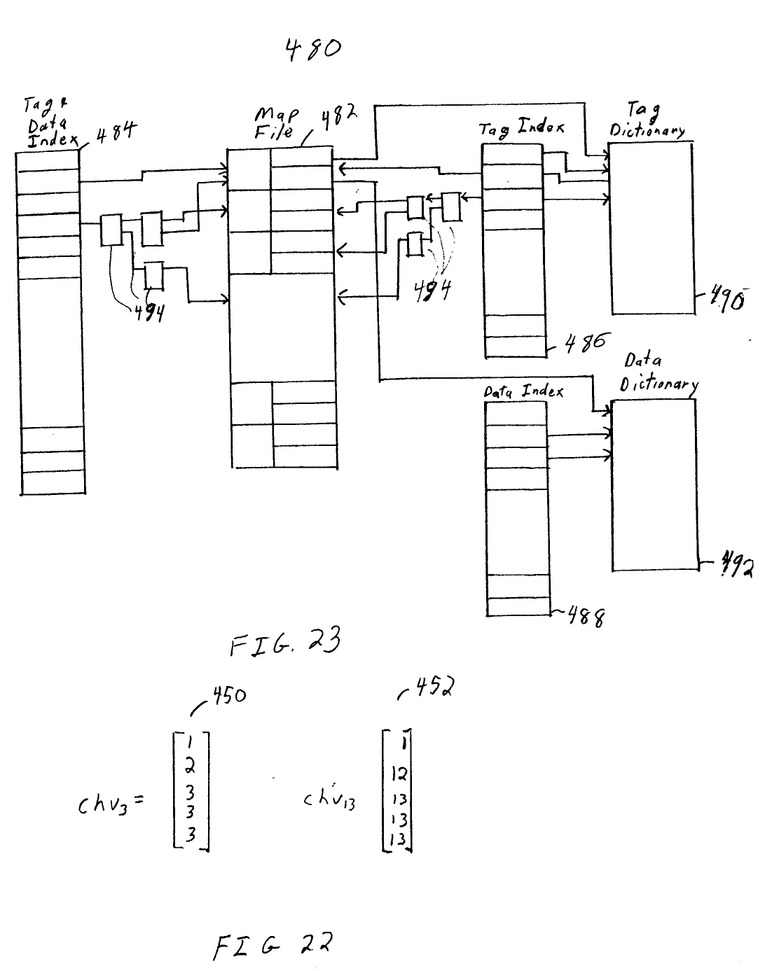

FIG. 22 is a pair of examples of couplet hierarchical vectors 450 & 452 in accordance with one embodiment of the invention. The couplet hierarchical vectors were created from the XML document of FIG. 20 and the associated flattened document of FIG. 21. A Couplet Hierarchical Vector (CHV) is a vector of numbers that provides the entire heritage of a couplet in terms of the couplet line number of itself and all of its ancestors. A couplet is a metdata/data pair. Each line of the flatten data document of FIG. 21 is a couplet. The size of a CHV is the depth of the couplet. For example, CHV 450 describes flattened line 3 of the flattened structured data document of FIG. 21. The size of the CHV 450 is 5 (five numbers), because the depth of the couplet is five. In other words there are five entries in line three: 1) Brandin, 2) Last>, 3) Name>, 4) Listing> and 5) Phonebook>. The last entry, Brandin, is a data entry. The vector numbers (1,2,3,3,3) represent the first open offset for each entry. Brandin first appears on line three so the offset is three. Last> is a tag that is first opened on line three, so the offset is three. Name> is a tag that is first opened on line three, so the offset is three. Listing> is a tag that is first opened on line two, so the offset is two. Phonebook> is a tag that is first opened on line one, so the offset is one. Ordering the plurality of offsets forms the CHV.

This process can be formalized and CHVs built recursively using the P-Level, Parent, and couplet line number information. Start by setting the index d to the depth of the given couplet at line number n. Then set chvₙ[d]=n. Decrement d. If d<P-Level then set chvₙ[d]=Parent and go to the parent's flattened line. Else, set chvₙ[d]=n. Repeat the process until the root node is reached, i.e. when d=1. In this fashion, the CHV for a given couplet can always be constructed from the Parent and P-Level information, which means the CHV's for couplets does not have to be stored.

The CHV 452 is associated with line number 13 of the flattened structured data document of FIG. 21. Using the process described above, we set the index d to the depth of five. Next we set the offset equal to the line number so, chv₁₃[5]=13. Thus the least significant offset or last vector input is equal to 13. Next we decrement the vector index d, so d equals four. Then we determine if the vector index is less than the p-level (d<P-Level). The p-level for line 13 is three, so the vector index is not less than the p-level. Thus we set the decremented vector input, chv₁₃[4], equal to the line number, thirteen. Decrementing the index results in d being equal to three, which is not less than the p-level. As a result, the vector input, chv₁₃[3], is equal to thirteen. Decremening the index again results in d being equal to two, which is less than the p-level. Thus we set the vector input or offset, chv₁₃[2], equal to the parent which is twelve for line thirteen. We then proceed at the parent's flattened line. Decrementing the index results in d being equal to two, which is less than the p-level of three for line twelve. Thus we set the vector input or offset, chv₁₃[1], equal to the parent which is one for line twelve. This corresponds perfectly with the CHV 452 of line thirteen. Note that chv₁₃[1] is considered the most significant offset and chv₁₃[5] is considered the least significant offset.

The CHVs are used in creating ordered sets for the indexes of system for storing flattened data documents. FIG. 23 is a schematic diagram of a system 480 for storing flattened data documents in accordance with one embodiment of the invention. The system 480 has a map file 482 that stores a flatten structured data document or several flattened structured data documents. Searches and queries against the document(s) are expedited by the indices such as a tag & data index 484, a tag index 486 and a data index 488. The map file 482 is compressed by using a tag dictionary 490 and a data dictionary 492. When there are duplicates of entries in the tag and data index 484 or the tag index 486 a duplicate tree is created 494. The duplicate trees 494 are ordered based on couplet hierarchical vectors. Once there are additions and deletes it is necessary to use couplet hierarchical vectors to order the duplicates for an entry. As a simple example we will order the two couplet hierarchical vectors 450 & 452. Note that these two CHVs 450 & 452 are not duplicates. First the most significant offset of the first vector 450 chv₃[1] is compared to the most significant offset chv₁₃[1] of the second vector 452. Both offsets are one. So we move to the next most significant offset and the first vector's 450 value is two while the second vector's value 452 is twelve. As result the first vector 450 is ordered before the second vector 452. Each offset is compared until they are unequal. When the offset for the same position in the vector differ, this determines the ordering.

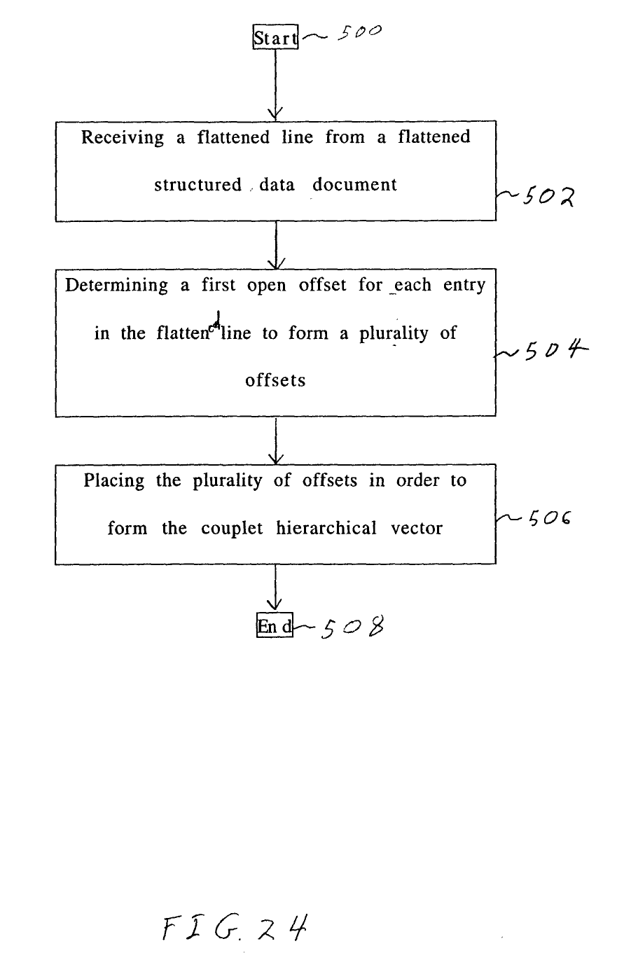

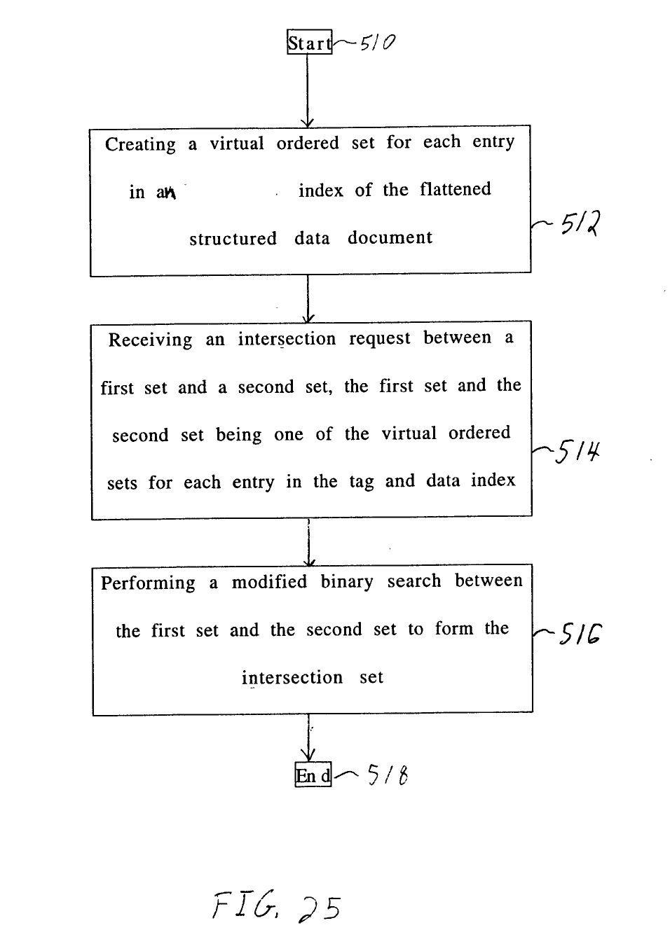

FIG. 24 is a flow chart of a method of defining a couplet hierarchical vector in accordance with one embodiment of the invention. The process starts, step 500, by receiving a flattened line from a flattened structured data document at step 502. Next a first open offset for each entry in the flattened line is determined to form a plurality of offsets at step 504. At step 506, the offsets are placed in order to form the couplet hierarchical vector, which ends the process at step 508. The first open offset for the last entry in the flattened line is the offset for the flattened line when the last entry is data. A next entry is a tag in one embodiment. The first open offset for a tag is defined by a first previous line for which the tag is opened. This process is repeated for each entry in the flatten line to form the couplet hierarchical vector.

In one embodiment, the couplet hierarchical vector is determined by setting a vector index to a depth of the flattened line to form a last vector input. Next, the last vector input is set to an offset of the flattened line. The vector index is decremented to form a first decremented vector input. If the decremented index is not less than a p-level, the decremented vector input is set to the offset of the flattened line. When the decremented index is less than the p-level, the decremented vector input is set equal to a parent for the flattened line. The process then proceeds to the parent line. The process is repeated until the decremented index is equal to zero.

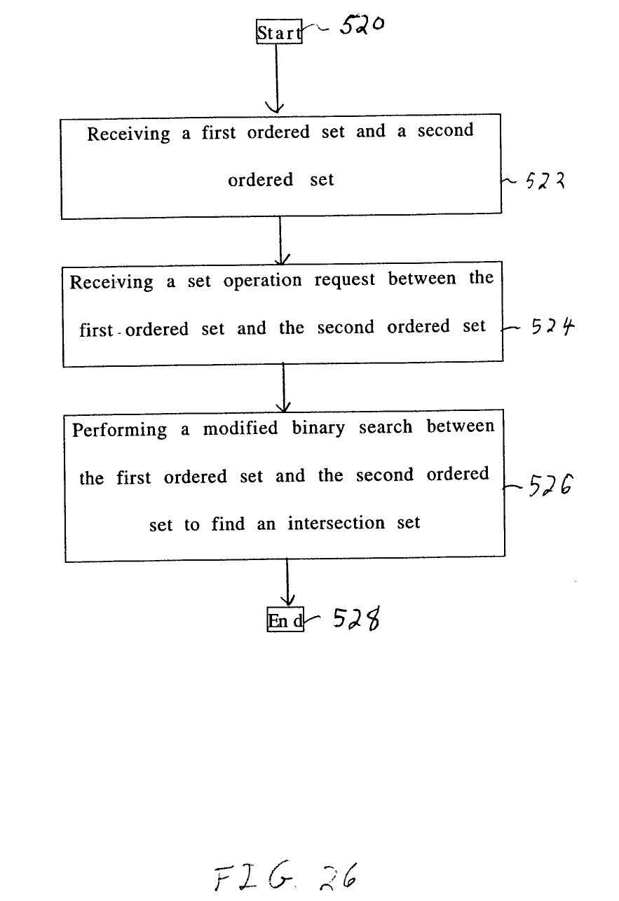

FIG. 25 is a flow chart of a method of performing set operations on a flattened structured data document in accordance with one embodiment of the invention. The process starts, step 510, by creating a virtual ordered set for each entry in an index of the flattened structured data document at step 512. An intersection request between a first set and a second set is received at step 514. The first set and the second set are one of the virtual ordered sets for each entry in the tag and data index. At step 516, a modified binary search is performed between the first set and the second set to form the intersection set which ends the process at step 518. In one embodiment, a couplet hierarchical vector is determined as needed for each member of the virtual ordered set. The couplet hierarchical vectors are compared by comparing a most significant offset of a first couplet hierarchical vector to a most significant offset of a second couplet hierarchical vector. When the most significant offset of the first couplet hierarchical vector is less than the most significant offset of the second couplet hierarchical vector, ordering a first entry associated with the first couplet hierarchical vector before the second entry associated with the second couplet hierarchical vector. When the most significant offset of the first couplet hierarchical vector is equal to the most significant offset of the second couplet hierarchical vector, comparing a next most significant offset of the first couplet hierarchical vector to a next most significant offset of the second couplet hierarchical vector. In one embodiment it is determined if the first set has fewer entries than the second set. When the first set has fewer entries than the second set, a binary search of the second set is performed using a first member of the first set. The binary search of the second set is repeated for each entry of the first set. When a match is found, a plurality of members are eliminated from the second set to form a reduced set. A next member in the first set is selected and a binary search for the next member is performed on the reduced set.

In one embodiment when a result is found, a plurality of members are eliminated from the second set to form a reduced set. A next member is selected from the first set and a binary search is performed for the next member on the reduced set. In one embodiment, the process of eliminating includes determining members of the second set logically excluded from the first set. For instance, if the two ordered sets are (125, 250, 305) and (1, 5, 99, 102, 150, 201) and the first element select is 125 from the first set. Then the result would be that there is no match however the closest element is 102 which is lower than 125. Thus the elements 1, 5, 99 and 102 are logically eliminated.

FIG. 26 is a flow chart of a method of performing set operations on ordered sets in accordance with one embodiment of the invention. The process starts, step 520, by receiving a first ordered and a second ordered set at step 522. A set operation request is received between the first ordered set and the second ordered set at step 524. At step 526 a modified binary search is performed between the first ordered set and the second ordered set to find an intersection set which ends the process at step 528. The set operation may be an intersection operation or a union operation or other operation.

In one embodiment an ordered set for each of the plurality of entries in an index of a flattened structured data document are created. The ordered sets are created by determining a couplet hierarchical vector for each duplicate entry in the index of the flattened structured data document.

In one embodiment, a first member from the first ordered set is selected. A binary search is performed for the first member in the second ordered set. When a result is found, a plurality of logically eliminated members are removed from the second set to form a reduced second set. Next, a first member is selected from the reduced second set. A binary search is performed on the first set for the first member from the reduced second set. When a result is found in the reduced second set, a plurality of logically eliminated members are removed from the first set to form a reduced first set. This process of eliminating the logically eliminated members from a set is a modified binary search. The modified binary search also commonly involves switching back and forth between the sets. In a union set operation it is necessary to eliminate redundant members. The redundant members are the intersection set. As a result, the intersection set is necessary for both union and intersection operations.

The hierarchical structure of XML documents may be broken down into information couplets. The information couplet is a metadata/data pair where the metadata is the context of the data, derived from the XML tag structure. Couplet hierarchical vectors (CHVs) provide a means of tracking, operating on, and reconstructing the hierarchical structure of XML documents from a set of couplets.

Couplet Hierarchical Vectors

The best way to understand CHVs is to start with an example. We will take a simple XML document, break it down into its couples, and then define the CHVs from the couplets. Each couplet will have an associated CHV. Along the way we will review the Parent and P-Level numbers associated with the couplets. These two numbers, along with the couplet line number and depth may be used to construct the CHVs.

FIGS. 21 & 22 provides an example XML document followed by the flattened couplet structure. Carefully study the flattened couplet structure along with the Parent and P-Level numbers provided. Each couplet has a unique line number associated with it. In this particular case, the couplet line numbers are generated by numbering the couplets as they are extracted from the original XML document. Once additions, deletions and modifications are made, the couplet line numbers will not appear so nicely related to the original XML document. The key is that each couplet will retain a unique line number.

The Parent and P-Level numbers encode the hierarchical structure of the XML document in the flattened couplet space. As can be seen, each couplet captures the entire tag structure up to the given data element. As such, a given flattened line may contain the parent structure of several lines of the original XML document. The Parent number is the line number of the parent of the given couplet. The sticky issue here is that since a couplet contains the entire parent tag structure up to the data item, which parent are we referring to? Lets see if we can clarify this issue.

First, a few definitions and nomenclature. We will refer to the depth that a given item resides at. Look at line three of the flattened XML document. In the couplet tag structure, “Phonebook” is at depth 1, this is the shallowest depth and may be referred to as the root. Items go deeper from here. “Listing” is at depth 2, “Name” at depth 3, and so on out to the data item “Brandin”, which is at depth 5. The couplet depth is the depth of the deepest item of the couplet, in this case it is 5. In this case there is no data item associated with the couplet, Null data, the depth of the couplet will be the depth of the tag structure plus 1. In most cases, this is a moot point. The parent of “Name” is “Listing”, and the children of “Name” are “Last” and “First”.

Now lets walk through the creation of the Parent number for several lines of the flattened XML document. Line one contains the root node of the document, “Phonebook”. A parent does not exist for this item, so the Parent number points back to itself, 1, i.e. the parent of “Phonebook” is “Phonebook”. This will be true only for the root node of a document: the Parent number will point back to itself. On line two, we see the tag “Listing”. The parent of “Listing” is “Phonebook” which resides on line one, so Parent is 1. On line three, the parent of “Last” is “Name”, but “Name” occurs for the first time on the same line. It would be of little value to have Parent point back to itself. So we go back one level and look at “Name”. The parent of “Name” is “Listing”. “Listing” opened up on a previous line, so we will set Parent to the line “Listing” opened up on, line 2. On line four, the parent of “First” is “Name”. Since “Name” opened up on a previous line, Parent will be 3. Looking at one more line, line five, lets start at the data depth, 5. “1502” is contained in “Number” which appears for the first time on line 5. So we look at “Number” whose parent is “Address”, which also appears for the first time on this line. The parent of “Address” is “Listing”, so Parent will be 2. It is worth your time to go through the rest of the document and see if you can justify each Parent number. Notice that as one “Listing” closes out in the XML document and another “Listing” opens, the Parent reference numbers change in the flattened document. By simply looking at the flattened document without the Parent number, it would be impossible, in general, to tell when these changes occur.

The P-Level works in conjunction with the Parent. The P-Level tells us at which depth a new tag hierarchy takes effect or opens up. Look at line two of the flattened document in Appendix 1. The P-Level is 2. This indicates that “Listing” appears for the first time or opens up on this line. On line three, the P-Level is 3 because “Name” opened up on this line and “Name” is at depth 3. The P-Level is defined as the depth of the first item on the couplet that opens up on that line. The P-Level captures the change in the hierarchy structure. If you lay the original XML document on its side, with the shallowest tags up, it can be seen that the P-Level captures the peaks of the opening tags. Now go through the rest of the flattened document and see if you can justify each of the P-Level numbers. Notice on line twelve that P-Level dropped to 2, indicating that “Listing” re-opened on this line.

Now we come to the Couplet Hierarchical Vector (CHV). The CHV is a vector of numbers that gives the entire heritage of a couplet in terms of the couplet line number of itself and all of its ancestors. The size of the CHV will be the depth of the couplet. For example, the CHV of the flattened line number three is:

$$c h {v}_{3} = [ \begin{matrix}1 \\ 2 \\ 3 \\ 3 \\ 3\end{matrix} ] \qquad ( 0.1 )$$

The size of chv₃ is 5 because the depth of couplet three is 5. The first item in chv₃ represents the root node, “Phonebook”, which opened on line 1. The second item represents “Listing”, which opens up on line 2. The third item represents “Name”, which opens up on line 3. Item 4 represents “Last”, which opens up on line 3, and finally, item 5 represents “Brandin”, which exists on line 3 also. Look at the next two examples from the flattened lines 15 and 26. See if you can justify the vector numbers.

$$c h {v}_{15} = [ \begin{matrix}1 \\ 12 \\ 15 \\ 15 \\ 15\end{matrix} ]$$

$$c h {v}_{3} = [ \begin{matrix}1 \\ 22 \\ 24 \\ 26 \\ 26\end{matrix} ]$$

The CHV can be built in a recursive manor using the P-Level, Parent, and couplet line number information. Start by setting the index d to the depth of the given couplet at line number n. The set chvₙ[d]=n. Decrement d. If d<P-Level then set chvₙ[d]=Parent and go to the parent's flattened line. Else, set chvₙ[d]=n. Repeat the process until the root node is reached, i.e. when d=1. In this fashion, the CHV for a given couplet can always be constructed from the Parent and P-Level information, which means the CHV for couplets does not have to be stored.

Properties of Couplet Hierarchy Vectors

In this section we will establish a number of the properties of CHVs. This will allow us to determine virtual document order and to perform set manipulations based on CHVs. First we will note a couple of fundamental properties of XML documents that we will take advantage of.

The ordering of elements in an XML document at a given hierarchy level does not matter. We will consider two XML documents equivalent if they only differ by the ordering of elements within a given hierarchy. For example, the following two XML documents are considered equivalent:

Document 1:

<A>

<B>

<C1>c-1</C1>
<C2>c-2</C1>

</B>
<D>

<C1>c-3</C1>
<C2>c-4</C1>

</D>

</A>

Document 2:

<A>

<D>

<C2>c-4</C1>
<C1>c-3</C1>

</D>
<B>

<C2>c-2</C1>
<C1>c-1</C1>

</B>

</A>

The tag names uniquely identify elements within a hierarchy level so ordering imparts no new or implied information.

Each element in an XML document has a unique parent, and, if two elements have the same parent, then the rest of the ancestry for the two elements is the same. These two statements are obvious from the structure of an XML document.

Containment of elements within the same hierarchy in an XML document implies a relationship between the elements. The containment of “Last” and “First” within the “Name” element in our phone book example implies “Chris” and “Brandin” are related. In the same sense, an attribute element modifies the elements contained within the given hierarchy. “Residential” within the “Listing” hierarchy implies the “Chris Brandin” is a resident of Colorado Springs and not a “Business” in Colorado Springs.

CHV Property 1: For any two CHVs and a given depth, d,

If chv₁[d]=chv₂[d] then

chv₁[i]=chv₂[i] for i=1 to d (0.2)

This property comes from the XML document property that if two elements have the same parent then the rest of the ancestry is the same. We will also say that when condition 0.2 is met, chv₁ and chv₂ are contained within the same hierarchy element at level d if the depths of the two CHVs are greater than d.

CHV Property 2: For any two CHVs whose depths are greater than d,

If chv₁[d] = chv₂[d] AND chv₁[d + 1] ≠ chv₂[d + 1]

Then

| | |
|---|---|
| chv₁ < chv₂ if chv₁[d + 1] < chv₂[d + 1] | (0.3) |

Else

chv₁ > chv₂

If the depth of chv₁ equals d and the depth of chv₂ is greater than d,

and chv₁[d] = chv₂[d]

| | |
|---|---|
| then | (0.4) |

chv₁ < chv₂

Property two allows us to order a set of couplets based on the virtual XML document order. Virtual document order is the order that maintains the hierarchical structure of the XML document. The key to determining the order of two CHV's is to find the deepest depth, d, for which chv₁[d]=chv₂[d]. Then the depth, d+1 will determine the order. If the root nodes are different, then the two CHV's come from different documents and chv[1] may be used to determine document order. If chv₁ is not as deep as chv₂ and chv₁[d]=chv₂[d] at the depth d of chv₁, then chv₂ must come after chv₁ and we say that chv₂ is contained within the chv₁ element.

Demonstrate with a couple of insertions into the example Document

We can see how the ordering of CHVs work by looking at what happens when we insert a couple of items into our phone book document. Suppose we decided to add middle initials for Chris and Harry and also the postfix Jr. for Harry. The flattened lines with somewhat arbitrary insertion point line numbers are:

58 Phonebook>Listing>Name>MidInitial>G For Harry

97 Phonebook>Listing>Name>Midlnitial>L For Chris

126 Phonebook>Listing>Name>Post>Jr For Harry

We can insert these lines in the proper virtual document order by setting the CHVs to:

$$c h {v}_{G} = [ \begin{matrix}1 \\ 12 \\ 13 \\ 58 \\ 58\end{matrix} ]$$

$$c h {v}_{L} = [ \begin{matrix}1 \\ 2 \\ 3 \\ 97 \\ 97\end{matrix} ]$$

$$c h {v}_{J r} = [ \begin{matrix}1 \\ 12 \\ 13 \\ 126 \\ 126\end{matrix} ]$$

Notice that if we attempted to order these vectors at level 4 or 5 without taking into account the shallower levels, we would not maintain proper document order. Also notice that the vectors will not place the middle initial between the “Last” and “First” name within the hierarchy. This is not required. Remember that the tag structure contains the full description or context of the data item. The CHVs provide the hierarchical structure information.

CHV Property 3 (Containment): If chv₁ has depth d and chv₂ has a depth greater than d, then chv₂∈chv₁ (chv₂ is an element of or is contained in chv₁) if chv₂[d]=chv₁[d].

An example of vectors contained in other vectors which shows the hierarchy of the vectors is:

$$c h {v}_{G} = [ \begin{matrix}1 \\ 12 \\ 13 \\ 58 \\ 58\end{matrix} ] ∈ [ \begin{matrix}1 \\ 12 \\ 13 \\ 58\end{matrix} ] ∈ [ \begin{matrix}1 \\ 12 \\ 13\end{matrix} ] ∈ [ \begin{matrix}1 \\ 12\end{matrix} ] ∈ [ 1 ]$$

This brings up the interesting point that a single flattened line may represent several layers of the hierarchy and therefore may have several CHVs associated with it. For example, look at line 5 of the flattened XML document in appendix 1. Both “Address” and “Number” open up on this line and the data element “1502” is contained on this line. The related CHVs for this line are:

$$c h {v}_{5} = [ \begin{matrix}1 \\ 2 \\ 5 \\ 5 \\ 5\end{matrix} ] ∈ [ \begin{matrix}1 \\ 2 \\ 5 \\ 5\end{matrix} ] ∈ [ \begin{matrix}1 \\ 2 \\ 5\end{matrix} ]$$

In most instances, we will say that the CHVs for this line are distinct and therefore not equal. There are some instances where we will not make a distinction between the different CHVs and therefore call them equal. This is a fine point that must be kept in mind when working with CHVs and when defining set operations with them.

Convergence, Duplicates and Comparing CHVs

Couplet hierarchy vectors are typically compared at a shallower depth than their defined depth. This is due to the nature of the hierarchical documents and what we are looking for within them. Suppose we are searching through the phonebook for the listing of Chris Brandin on East Pikes Peak Avenue. The three associated CHVs are:

$$c h {v}_{C h r i s} = [ \begin{matrix}1 \\ 2 \\ 3 \\ 4 \\ 4\end{matrix} ]$$

$$c h {v}_{Brandin} = [ \begin{matrix}1 \\ 2 \\ 3 \\ 3 \\ 3\end{matrix} ]$$

$$c h {v}_{PikesPeak} = [ \begin{matrix}1 \\ 2 \\ 5 \\ 6 \\ 6\end{matrix} ]$$

Clearly these are distinct vectors and cannot be compared at their full depth of 5. If we compare these vectors at the “Listing” level, depth 2, we see that each vector is equal at depth 2, and so they are all from the same listing and therefore we have a match at that level.

One of the vector operators we will use is convergence. Convergence truncates a vector to a shallower depth, d. When we converge a vector to a depth, d, we are effectively tossing out or ignoring deeper level information (all values in the CHV greater than d). The examples seen in the last section (property 3 on containment) shows examples of CHVs being converged one level at a time. Notice how a converged vector contains the vector being converged. This operation is used often when working with documents.

Indexes

All items within the map file are found via indexes. A tag index for street number would contain all the line items for:

Phonebook>Listing>Address>Number

The index in this case would contain:

5, 15, and 24

Since the example phone book document was built in order, this index ordering follows virtual document order. If we used this method for middle initials, we might have the index order as:

58 and 97

While this orders the index by leaf node order, these two items are not in virtual document order, which is the ordering we would get if we used the CHVs. Set operations on hierarchical documents are most efficient if the sets are in virtual document order. Since many of the sets are derived from the indexes, it is important that the indexes be in virtual document order.

Set Operations

Ordered sets allow set operations such as set intersection, set union, and other set operations that will be defined later, to be carried out much more efficiently than if the sets are not ordered. For instance, a binary search algorithm may be performed on an ordered set whereas a binary search cannot be performed on an unordered set.

We will call A an ordered set of CHVs if:

A={a₁ a₂ a₃ . . . a_{n}} (0.5)

where the elements are such that aⱼ≧aᵢ for all j>i

A will be a properly ordered set if aⱼ>aᵢ for all j>i.

If we have a properly ordered set A of CHVs, converging each element to a shallower depth will in general create duplicates within the set making the set simply ordered. This must be kept in mind during set operations. Often we will start with two properly ordered sets, and elements of one or both sets will be converged to lower levels when creating duplicates within that set. These duplicates often must be removed from the final output set.

Binary Search on an Ordered Set of CHVs

A binary search is a well know algorithm for finding an element within a given set. A binary search will find a given element within an ordered set of n elements (if it exist within the set) in less than or equal to log₂(n)+1 steps. This is substantially faster than going through each element of a large set one-by-one comparing each element it to a target element. I will not give the details of a binary search here because it is such a well known algorithm. I will point out a few issues that have to do with binary searches on a set of CHVs though.

We will assume that A is an ordered set of CHVs for this discussion and chvₙ is the item we are searching for. A may be properly ordered, but if we are comparing the elements of A at a depth that is shallower than the element's depths, duplicates may be introduced. The elements of A may have different depths associated with each element. The depth that each element in A, aᵢ, is compare to chvₐ at may be:

1) a defined depth d,

2) the depth of chvₐ,

3) the depth of the element aᵢ,

The depth of comparison will depend on the definition of the set operation being performed. This is a place where the definition of equality between CHVs is important. See the section “Convergence, Duplicates and Comparing CHVs” above.

If chvₐ∈A, then the binary search routine returns the index of the item found, along with a flag indicating a match was found. If there are duplicates of chvₐ in A, then the index of the first duplicate element found will be returned. It will be the responsibility of the calling routine to check for duplicates around the item found if this is necessary.

If chvₐ∉A then the binary search routine returns the index of the element that is just greater than or just less than chvₐ, along with a flag indicating greater than or less than match. If j is the index returned, we will have one of the two cases:

aⱼ₋₁<chvₐ<aⱼ if less than is returned (aⱼ could be the first element of A)

aⱼ>chvₐ>aⱼ₊₁ if greater than is returned (aⱼ could be the last element of A)

Binary search routines will be used heavily in the set operations described below.

A Fast Set Intersection and Union Algorithm

A variety of set operations are used when querying and processing XML information. The sets that are dealt with are often quite large, so efficient set operators are fundamental. The easiest way to understand the basis of the various fast set operations is to study a simple set intersection operation.

Let A and B be two properly ordered sets:

A={a₁ a₂ a₃ . . . aₙ} where aⱼ>aᵢ for all j>i

B={b₁ b₂ b₃ . . . bₘ} where bⱼ>bᵢ for all j>i

For a set intersection we are looking for the properly ordered set C where:

C=A∩B

First, if the sets A and B were not ordered, the set intersection process would require searching through all element of B for each element of A, looking for matches. When a match is found, the element is added to set C This process would require on the order of m×n steps, which is terribly inefficient. Having ordered sets allows us to speed up this process considerably by using binary searches.

Using a binary search and comparing set A to set B, for each element of A, aᵢ, we would do a binary search of set B looking for the element aᵢ. If aᵢ is found in set B, aᵢ will be added to set C. This process will take on the order of n[log₂(m)+1] steps. For a large set B, this will be considerably faster than using unordered sets. Clearly to make this process as fast as possible, we will want to compare the smaller set against the larger set. Note that because A is a properly ordered set, the result set C will be a properly ordered set.

The next improvement comes from noting that since both A and B are ordered sets, once we perform a binary search on B looking for aᵢ, the next binary search can be on a smaller set. The binary search of B returns an index of B indicating a match or the closest match above or below aᵢ. Lets say the element found is bⱼ. When we go to look for aᵢ₊₁ in the set B, clearly aᵢ₊₁≧bⱼ so we may perform the binary search of aᵢ₊₁ against the smaller set B—{b₁ . . . bⱼ₋₁}. In other words, each binary search is preformed against a shrinking set of elements in B, thus further reducing the number of steps required below n[log₂(m)+1] steps.

The next optimization is best described by looking at a concrete example. Consider the two sets:

A={5,6,7,9,15,18,47,48,49,86,105,107}

B={9,10,11,12,48,91,92,93,97,105,133,138,150}

We will start by looking for 5 in set B. Since 5 is less than 9, 5 is not in B, the search will return the index 1 with a less than flag (we did not even need a binary search to determine this). We could continue looking for 6 and 7 in set B, or we can switch our search order and look for 9 in set A—{5} with a binary search which will return the index 4 (for element 9) with a match flag. Notice that by switching the search order, we were able to skip two searches that would not have produced matches.

At this point we can look for 10 in set A or 15 in set B. Since our last search was an element of B against the set A, we will continue with this process until there is a reason to change. So we look for 10 in the set:

A—{5,6,7,9} or the set: {15,18,47,48,49,86,105,107}

which returns the index for element 15 with a less than flag. This is our indication to reverse the search order again. We now look for 15 in the set B—{9,10} with a binary search which will result in finding either element 12 with a greater than flag, or 48 with a less than flag depending on implementation details of the binary search algorithm. If we land on 48 with a less than flag, or next search will be element 48 from set B against the reduced set A. We continue this process until one of the sets runs out of elements.

Let's count up the number of steps for this example. A step consists of comparing an element of one set against the first element of the other set, a possible binary search and a reversal decision. The enumerated steps are:

1. Compare A5 against B9, reverse search order

2. Compare B9 against A6, Binary Search, find A9

3. Compare B10 against A15, reverse search order

4. Compare A15 against B11, Binary search find B48<, reverse search order

5. Compare B48 against A18, Binary search, find A48

6. Compare B91 against A49, Binary search, find 86<, reverse search order

7. Compare A105 against B92, Binary search, find B105

8. Compare A107 against B133, Stop Search.

The whole process took 8 steps and only 5 binary searches. This is less steps than the smaller of the two sets. Set A contains 12 elements. There were less than half as many binary searches required by this process than elements in the smaller of the two sets.

It is clear that by this process of reversing the search order, we will jump through the intersection of the two sets with the minimal number of steps and binary searches. In fact, we will use less binary searches than the number of elements in the smaller of the two sets, and the sets that we are doing binary searches against become smaller and smaller as the process continues. This makes for a very fast algorithm for set intersection.

A Fast Set Union Algorithm

The same process that was used to speed up set intersection may be used to speed up a set union. Here we will define the union of two properly ordered sets A and B to be a properly ordered set C than contains all of the elements of both A and B without including any duplicates.

C=A∪B

If you think about it, the primary difference between the set intersection and the set union is what is kept. In the set intersection process, we searched through both sets looking for common elements and kept only one copy of the common elements and tossed all non-common elements. In set union, we have to search though both sets looking for common elements, keeping only one copy of the common elements, plus we keep (instead of tossing) all non-common elements. With this in mind, it is easy to see how to modify the fast intersection algorithm to perform the fast set union algorithm. Using the above example again,

A={5,6,7,9,15,18,47,48,49,86,105,107}

B={9,10,11,12,48,91,92,93,97,105,133,138,150}

this time taking the union, the steps are:

1. Compare A5 against B9, add A5 to C, reverse search order.

2. Compare B9 against A6, Binary Search, find A9, add A6-A9 to C.

3. Compare B10 against A15, add B10 to C, reverse search order.

4. Compare A15 against B11, Binary search find B48<, add B11-B12 to C, add A15 to C, reverse search order.

5. Compare B48 against A18, Binary search, find A48, add A18-A48 to C.

6. Compare B91 against A49, Binary search, find 86<, add A49-A86 to C, add B91 to C, reverse search order.

7. Compare A105 against B92, Binary search, find B105, add B92-B105 to C.

8. Compare A107 against B133, add A107 to C, add B133-B150 to C. Stop Search.

Notice that the union operation on the same sets resulted in the same number of steps and the same number of binary searches as the intersection operation. The only difference in the two processes is that the union operator kept more items.

Couplet Hierarchical Vector Set Operations

Set operations involving CHVs are similar to normal set operations, but they must be more carefully defined. The key issue is that the CHVs contain more information than simple numbers. The level that the CHV's are compared at must be defined and the level the CHV's are returned at must be defined.

Get Index Set (Get Single Set)

This operation creates a properly ordered set A by retrieving an index set, converging the CHV's from the index set to a given depth, and removing all duplicate items.

As noted above in the section on indexes, an index contains a list of all line numbers (map offsets) for something like a tag:

Phonebook>Listing>Address>Number: 5,15,24

If our interest in Address-Numbers is at the listing level, these items (5,15, and 24) would be converged back to the Listing level giving:

A={2,12,22}

In this particular case, there were no duplicates introduced during the convergence process. In general though, a converge may introduce duplicate items. Because the indexes are established in virtual document order removing duplicates is a simple process. Before adding the next item to the set A, the previous item in set A is compared, at the converged depth, to the new item. If the two items are equal, the new item is tossed, if they are not equal, the new item is added to A.

CHV Set Intersection

This operation creates a properly ordered set C from the intersection of two properly ordered sets A and B of CHVs:

C=A∩_{chv}B

The elements of A may be defined at various depths and the elements in B may also be defined at various depths. The elements a∈A and b∈B are considered equal if they are both defined as having the same depth, d, and a[d]=b[d], otherwise they are not considered equal. The intersection of sets A and B may be carried out by the process given above using this definition.

CHV Set Union

This operation creates a properly ordered set C from the union of two properly ordered sets A and B of CHVs:

C=A∪_{chv}B

Once again, the elements of A may be defined at various depths and the elements in B may also be defined at various depths. The elements a∈A and b∈B are considered equal if they are both defined as having the same depth, d, and a[d]=b[d], otherwise they are not considered equal. The union of sets A and B may be carried out by the process given above using this definition.

Hierarchical Vector Correlation

This operation creates a properly ordered set C from the intersection of two properly ordered sets A and B of CHVs:

C=A∩_{hvc}B

The elements of A may be defined at various depths. The elements in B may also be defined at various depths with the condition that depths of elements in B are greater than or equal to the depths of corresponding elements in A. An element, b, of B corresponds to an element, a, of A if b is a child or sibling of a or could logically be a child or sibling of a. An example of this is that “City” is a child of “Address” in terms of the document structure.

The elements of C will be all elements of B that correlate with an element of A. This is a set intersection process whereby the elements of B are compared with the elements of A at the depth of the elements of A. If b∈B matches a∈A at a's depth, then b is added to C. The set intersection process defined above may be used with this definition to perform the hierarchical vector correlation.

Various other set operations may and have been defined using couplet hierarchical vectors. The set operations are variations of set intersection and set union operations where the depth of comparing the CHVs must be carefully defined along with the depth of the elements added to the resultant set. The above set operations provide examples of the type of operations that can be performed.

Couple hierarchical vectors provide effective and efficient mechanism to order, work with and manipulate hierarchical objects such as XML documents. Without virtual document ordering via CHV's, efficient set operations on these hierarchical objects are impossible. Binary search algorithms (or other similar algorithms) may be defined and used on sets of ordered CHV's. This makes a wide variety of set operations much faster.

A very efficient algorithm (modified binary search) has been given for performing operations on ordered sets. This algorithm may provide orders of magnitude speed improvements over other set intersection and union methods depending on the structure of the items in the sets.

Several set operations have been defined based on hierarchical objects using CHV's. The defined set operations provide examples of the type of operations that may be performed on hierarchical objects such as XML documents. Note that the examples shown herein were operations between two sets, however the methods apply equally to operations across multiple sets which will be apparent to those skilled in the art.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A method of defining a couplet hierarchical vector, comprising:
a) receiving a flattened line from a flattened structured data document;
b) determining a first open offset for each entry in the flattened line to form a plurality of offsets; and
c) placing the plurality of offsets in order to form the couplet hierarchical vector.

2. The method of claim 1, wherein the first open offset for the last entry in the flattened line is the offset for the flattened line.

3. The method of claim 2, wherein a next entry is a tag.

4. The method of claim 3, wherein the first open offset for the tag is defined by a first previous line for which the tag is opened.

5. The method of claim 4, wherein the process is repeated for each entry in the flatten line.

6. The method of claim 2, wherein step (b) further includes the steps of:
b1) setting a vector index to a depth of the flattened line to form a last vector input;
b1) setting the last vector input to an offset of the flattened line.

7. The method of claim 6, further including the steps of:
b3) decrementing the vector index to form a first decremented vector input;
b4) determining if the decremented index is less than a p-level;
b5) when the decremented index is not less than the p-level, setting the decremented vector input to the offset of the flattened line.

8. The method of claim 7, further including the steps of:
b6) when the decremented index is less than the p-level, setting the decremented vector input equal to a parent for the flattened line.

9. The method of claim 8, further including the steps of:
b7) proceeding to the parent line.

10. The method of claim 9, further including the steps of:
b8) repeating the process until the decremented index is equal to zero.

11. A method of performing set operations on a flattened structured data document, comprising the steps of:
a) creating a virtual ordered set for each entry in an index of the flattened structured data document;
b) receiving an intersection request between a first set and a second set, the first set and the second set being one of the virtual ordered sets for each entry in the index; and
c) performing a modified binary search between the first set and the second set to form an intersection set.

12. The method of claim 11, wherein step (a) further includes the step of using a couplet hierarchical vector for each member of the virtual ordered set.

13. The method of claim 11, where step (a) further includes the steps of:
a1) comparing a most significant offset of a first couplet hierarchical vector to a most significant offset of a second couplet hierarchical vector;
a2) when the most significant offset of the first couplet hierarchical vector is less than the most significant offset of the second couplet hierarchical vector, ordering a first entry associated with the first couplet hierarchical vector before the second entry associated with the second couplet hierarchical vector.

14. The method of claim 13, further including the steps of:
a3) when the most significant offset of the first couplet hierarchical vector is equal to the most significant offset of the second couplet hierarchical vector, comparing a next most significant offset of the first couplet hierarchical vector to a next most significant offset of the second couplet hierarchical vector.

15. The method of claim 11, wherein step (c) further includes the steps of:
c1) determining if the first set has fewer entries than the second set;
c2) when the first set has fewer entries than the second set, performing a binary search of the second set using a first member of the first set.

16. The method of claim 15, further including the steps of:
c3) repeating the binary search of the second set for each entry of the first set.

17. The method of claim 15, further including the steps of:
c3) when a match is found, eliminating a plurality of members from the second set to form a reduced set;
c4) selecting a next member in the first set;
c5) performing a binary search for the next member on the reduced set.

18. The method of claim 15, further including the steps of:
c3) when a result is found, eliminating a plurality of members from the second set to form a reduced set;
c4) selecting a next member in the first set;
c5) performing a binary search for the next member on the reduced set.

19. The method of claim 18, wherein step c3) further includes the steps of:
i) determining a plurality of members of the second set logically excluded from the first set.

20. The method of claim 15, further including the steps of:
c3) when a result is found, eliminating a plurality of members from the second set to form a reduced set;
c4) selecting a first member in the reduced set;
c5) performing a binary search for the first member of the reduced set on the first set.

21. The method of claim 20, further including the steps of:
c6) when a result is found in the first set, eliminating a plurality of first set members to form a reduced first set.

22. A method of performing set operations, comprising the steps of:
a) receiving a first ordered set and a second ordered set;
b) receiving a set operation request between the first ordered set and the second ordered set; and
c) performing a modified binary search between the first ordered set and the second ordered set to find an intersection set.

23. The method of claim 22, wherein step (b) includes the step of receiving an intersection operation.

24. The method of claim 22, wherein step (b) includes the step of receiving a union operation.

25. The method of claim 22, wherein step (a) includes the step of:
a1) creating an ordered set for each of the plurality of entries in a index of a flattened structured data document.

26. The method of claim 25, wherein step (al) further includes the steps of:
i) determining a couplet hierarchical vector for each duplicate entry in the index of the flattened structured data document.

27. The method of claim 22, wherein step (c) further includes the steps of:
c1) selecting a first member from the first ordered set;
c2) performing a binary search for the first member in the second ordered set.

28. The method of claim 27, further including the step of:
c3) when a result is found, eliminating a plurality of logically eliminated members from the second set to form a reduced second set.

29. The method of claim 28, further including the steps of:
c4) selected a first member from the reduced second set;
c5) performing a binary search on the first set for the first member from the reduced second set.

30. The method of claim 29, further including the steps of:
c6) when a result is found in the reduced second set, eliminating a plurality of logically eliminated members from the first set to form a reduced first set.
